(19) United States
(12) Patent Application Publication
(10) Pub. No.: US 2026/0106722 A1
(43) Pub. Date: Apr. 16, 2026

(54) METHOD AND DEVICE FOR DETERMINING BAND INFORMATION, DEVICE AND STORAGE MEDIUM

(71) Applicant: Beijing Xiaomi Mobile Software Co., Ltd., Beijing (CN)

(72) Inventor: Shengxiang GUO, Beijing (CN)

(73) Assignee: Beijing Xiaomi Mobile Software Co., Ltd., Beijing (CN)

(21) Appl. No.: 19/116,695

(22) PCT Filed: Sep. 29, 2022
(86) PCT No.: PCT/CN2022/122891

§ 371 Date: Mar. 28, 2025

(51) Int. Cl. H04L 5/00; H04L 1/1607

(52) U.S. Cl. CPC H04L 5/0098; H04L 1/1614; H04L 5/0044

(57) ABSTRACT

A method for determining band information is provided. The method is performed by a terminal device, and the method includes at least the following step: receiving indication signaling, where the indication signaling is used to determine whether at least one band supports uplink transmission via at least two ports.

### CROSS-REFERENCE TO RELATED APPLICATIONS

The present application is a U.S. National Stage of International Application No. PCT/CN2022/122891, filed on Sep. 29, 2022, the contents of all of which are incorporated herein by reference in their entireties for all purposes.

### BACKGROUND OF THE INVENTION

In New Radio (NR), the concept of Uplink Tx Switching is proposed. Uplink Tx Switching requires a terminal device to support an uplink transmission switching scheme of at most 3 or 4 bands.

When the terminal device supports Uplink Tx Switching, the use method of uplink bands needs to be further designed.

### SUMMARY OF THE INVENTION

A method and device for determining band information, a device and a storage medium are provided in the embodiments of the present disclosure, which limits a band corresponding to a concurrent antenna.

According to an aspect of the present disclosure, a method for determining band information is provided. The method is performed by a terminal device, and includes: receiving indication signaling, where the indication signaling is used to determine whether at least one band supports uplink transmission via at least two ports.

According to an aspect of the present disclosure, a method for determining band information is provided. The method is performed by a network device, and includes:
transmitting indication signaling, where the indication signaling is used to determine whether at least one band supports uplink transmission via at least two ports.

According to an aspect of the present disclosure, a terminal device is provided. The terminal device includes:
one or more processors; and
a transceiver connected to the one or more processors; where the one or more processors are collectively configured to: receive indication signaling, where the indication signaling is used to determine whether at least one band supports uplink transmission via at least two ports.

### BRIEF DESCRIPTION OF DRAWINGS

To more clearly illustrate the technical solutions in the embodiments of the present disclosure, a brief introduction to the drawings required for describing the embodiments are provided below. Apparently, the drawings in the following description are merely some embodiments of the present disclosure. Those of ordinary skill in the art can also obtain other drawings according to these drawings without creative efforts.

FIG. 1 is a schematic diagram of a communication system provided in an example of the present disclosure.

FIG. 2 is a schematic diagram of transmission via two ports provided in an example of the present disclosure.

FIG. 3 is a flowchart of a method for determining band information provided in an example of the present disclosure.

FIG. 4 is a flowchart of a method for determining band information provided in an example of the present disclosure.

FIG. 5 is a flowchart of a method for determining band information provided in an example of the present disclosure.

FIG. 6 is a flowchart of a method for determining band information provided in an example of the present disclosure.

FIG. 7 is a flowchart of a method for determining band information provided in an example of the present disclosure.

FIG. 8 is a flowchart of a method for determining band information provided in an example of the present disclosure.

FIG. 9 is a flowchart of a method for determining band information provided in an example of the present disclosure.

FIG. 10 is a flowchart of a method for determining band information provided in an example of the present disclosure.

FIG. 11 is a block diagram of a device for determining band information provided in an example of the present disclosure.

FIG. 12 is a block diagram of a device for determining band information provided in an example of the present disclosure.

FIG. 13 is a block diagram of a device for determining band information provided in an example of the present disclosure.

FIG. 14 is a block diagram of a device for determining band information provided in an example of the present disclosure.

FIG. 15 is a block diagram of a terminal device provided in an example of the present disclosure.

FIG. 16 is a block diagram of a network device provided in an example of the present disclosure.

### DETAILED DESCRIPTION OF THE INVENTION

To make the purpose, technical solutions and advantages of the present disclosure clearer, the implementations of the present disclosure will be further described in detail below with reference to the accompanying drawings.

Reference will be made in detail to examples, examples of which are illustrated in the accompanying drawings. When the following description refers to the drawings, the same numbers in different drawings represent the same or similar elements, unless otherwise represented. The implementations described in the following examples are not representative of all implementations consistent with the present disclosure. Rather, they are merely examples of devices and methods consistent with some aspects of the present disclosure as described in detail in the appended claims.

The terminologies used in the present disclosure are for the purpose of describing particular embodiments merely and are not intended to limit the present disclosure. As used in the present disclosure and the appended claims, the singular forms “a”, “an”, “said” and “the” are also intended to include the plural forms, unless the context clearly indicates otherwise. It is also to be understood that the term “and/or” as used here refers to and encompasses any or all combinations of one or more of the associated listed items.

It is to be understood that although the terms first, second, third or the like may be used in the present disclosure to describe various information, the information is not to be limited to these terms. These terms are used merely to distinguish one type of information from another. For example, without departing from the scope of the present disclosure, first information may also be referred to as second information, and similarly, second information may also be referred to as first information. Depending on the context, the word “if” as used here may be interpreted as “when” or “while” or “in response to determining”.

The information (including but not limited to user equipment information, user personal information, and the like), data (including but not limited to data for analysis, stored data, displayed data, and the like), and signals involved in the present disclosure are all authorized by the user or fully authorized by all parties, and the collection, use and processing of relevant data need to comply with relevant laws, regulations and standards of relevant countries and regions.

The present disclosure relates to the field of mobile communications, and in particular to a method and device for determining band information, a device and a storage medium.

First, the terms involved in the present disclosure are explained.

Frequency band (band): a band refers to a frequency range. The band may have an identifier. Bands with different identifiers correspond to different frequency ranges. For example, bands include but are not limited to band n1, band n22, band n72, etc. Each band corresponds to one frequency range. Each band has its own index or name.

Band switching: a terminal device supports at least two antennas and at least one band. In an uplink transmission scenario, each antenna can target one band, and one band can be simultaneously targeted by the at least two antennas. The “targeting” means that the terminal device can transmit, via the antenna, uplink data to a targeted band. Band switching refers to that one antenna of the terminal device is switched from targeting one band to targeting another band.

Priority: refers to a priority corresponding to each band. The priority corresponding to each band is used to indicate whether the bands can be switched.

In some embodiments, the priority includes a high priority and a low priority. That is, for one band, the band has either a high priority or a low priority.

Secondly, the application scenarios of the present disclosure are explained.

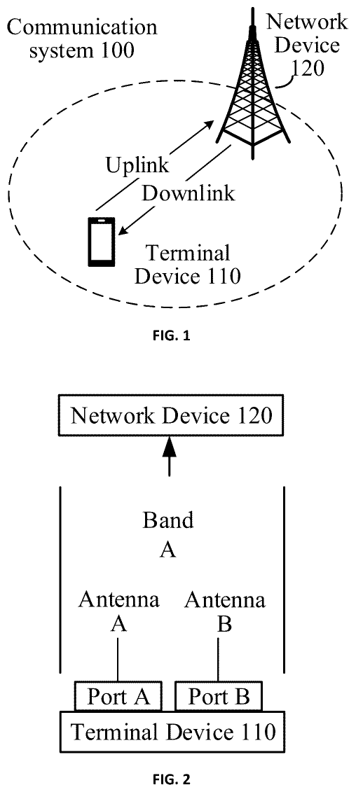

FIG. 1 shows a schematic diagram of a communication system 100 provided in an example of the present disclosure. The communication system includes a terminal device 110 and a network device 120.

The terminal device 110 in the present disclosure may also referred to as User Equipment (UE), an access terminal, a subscriber unit, a subscriber station, a mobile station, a mobile site, a remote station, a remote terminal, a mobile device, a user terminal, a terminal, a wireless communication device, a user agent, or a user device. The terminal includes but is not limited to, a handheld device, a wearable device, a vehicle-mounted device, an Internet of Things device, and the like, for example, a mobile phone, a tablet computer, an E-book reader, a laptop computer, a desktop computer, a television, a game console, a Mobile Internet Device (MID), an Augmented Reality (AR) terminal, a Virtual Reality (VR) terminal and a Mixed Reality (MR) terminal, a wearable device, a handle, an electronic tag, a controller, a wireless terminal in Industrial Control, a wireless terminal in Self Driving, a wireless terminal in Remote Medical, a wireless terminal in Smart Grid, a wireless terminal in Transportation Safety, a wireless terminal in Smart City, a wireless terminal in Smart Home, a wireless terminal in Remote Medical Surgery, a cellular phone, a cordless phone, a Session Initiation Protocol (SIP) phone, a Wireless Local Loop (WLL) station, a Personal Digital Assistant (PDA), a Set Top Box (STB), a Customer Premise Equipment (CPE), and the like.

The network device 120 in the present disclosure provides a wireless communication function. The network device 120 includes but is not limited to, an Evolved Node B (eNB), a Radio Network Controller (RNC), a Node B (NB), a Base Station Controller (BSC), a Base Transceiver Station (BTS), a home base station (e.g., Home Evolved Node B, or Home Node B (HNB)), a Baseband Unit (BBU), an Access Point (AP), a wireless relay node, a wireless backhaul node, and a Transmission Point (TP) or a Transmission and Reception Point (TRP) and the like in a Wireless Fidelity (Wi-Fi) system. The network device 120 may further be a Next Generation Node B (gNB) or transmission point (TRP or TP) in a 5th Generation (5G) mobile communication system. The network device 120 may be one or a group of antenna panels (including a plurality of antenna panels) of a base station in a 5G system. The network device 120 may further be a network node constituting the gNB or the transmission point, for example, a baseband unit (BBU) or Distributed Unit (DU), and the like. The network device 120 may be a base station in a Beyond Fifth Generation (B5G) mobile communication system, a 6th Generation (6G) mobile communication system, and the like, or a Core Network (CN), a Fronthaul, a Backhaul, a Radio Access Network (RAN), a Network Slice, and the like, or a serving cell, a Primary Cell (PCell), a Primary Secondary Cell (PSCell), a Special Cell (SpCell), a Secondary Cell (SCell), a neighbor cell and the like of the terminal device.

The terminal device 110 and the network device 120 communicate with each other via an air interface technology, for example, a Uu interface.

For example, there are two communication scenarios between the terminal device 110 and the network device 120: an uplink communication scenario and a downlink communication scenario. The uplink communication refers to transmitting a signal to the network device 120; the downlink communication refers to transmitting a signal to the terminal device 110.

The technical solutions provided in the embodiments in the present disclosure may be performed by various communication systems, for example, a Global System of Mobile communication (GSM) system, a Code Division Multiple Access (CDMA) system, a Wideband Code Division Multiple Access (WCDMA) system, a General Packet Radio Service (GPRS), a Long Term Evolution (LTE) system, a LTE Frequency Division Duplex (FDD) system, a LTE Time Division Duplex (TDD) system, an Advanced Long Term Evolution (LTE-A) system, a Universal Mobile Telecommunication System (UMTS), a Worldwide Interoperability for Microwave Access (WiMAX) communication system, a 5G mobile communication system, a New Radio (NR) system, an evolution system of the NR system, an LTE-based access to unlicensed spectrum (LTE-U) system, an NR-based access to unlicensed spectrum (NR-U) system, a Terrestrial Networks (TN) system, a Non-Terrestrial Networks (NTN) system, a Wireless Local Area Networks (WLAN), a Wireless Fidelity (Wi-Fi), a cellular Internet of Things system, a cellular passive Internet of Things system, and may further be applied to a subsequent evolution system of a 5G NR system, and may further be applied to B5G, 6G and subsequent evolution systems. In some embodiments of the present disclosure, “NR” may also be referred to as a 5G NR system or a 5G system. The 5G mobile communication system may include Non-Standalone (NSA) and/or Standalone (SA).

The technical solutions provided in the embodiments in the present disclosure may further be applied to Machine Type Communication (MTC), Long Term Evolution-Machine (LTE-M), a Device to Device (D2D) network, a Machine to Machine (M2M) network, an Internet of Things (IOT) network or other networks. The IoT network may include, for example, an Internet of Vehicles. Communication modes in an Internet of Vehicles system are collectively referred to as Vehicle to X (V2X, where X may indicate anything). For example, the V2X may include Vehicle to Vehicle (V2V) communication, Vehicle to Infrastructure (V2I) communication, Vehicle to Pedestrian (V2P) communication, or Vehicle to Network (V2N) communication, and the like.

FIG. 2 shows a schematic diagram of transmission via two ports provided in an example of the present disclosure.

The terminal device supports at least two uplink antennas and at least one band. Each uplink antenna can target one band, and one band is targeted by at most two uplink antennas. The “targeting” refers to that the terminal device can transmit, via the uplink antenna, uplink data to the targeted band.

An uplink transmission mode is shown in the FIG. 2. The terminal device 110 supports at least one band for uplink transmission. The terminal device 110 is configured with an antenna A and an antenna B. The antenna A uses a port A for uplink transmission in a band A, and the antenna B uses a port B for uplink transmission in the band A. In this case, the band A can support simultaneous uplink transmission via the port A and the port B.

For example, the terminal device 110 receives indication signaling from the network device 120, where the indication signaling is used to determine whether the at least one band supports uplink transmission via at least two ports. As shown in the FIG. 2, the band A supports the uplink transmission via the port A and the port B.

In the embodiment, a terminal device receives indication signaling, and determines, based on the indication signaling, whether the at least one band supports uplink transmission via at least two ports. This enables the terminal device in an Uplink Tx Switching scenario to determine which bands support uplink transmission via at least two ports and which bands do not support uplink transmission via the at least two ports. A network device can limit a part of bands to support uplink transmission via the at least two ports according to the terminal capability. The implementation complexity of the UE is reduced and a balance between complexity and switching flexibility are achieved.

FIG. 3 shows a flowchart of a method for determining band information provided in an example of the present disclosure. For example, the method is performed by the terminal device 110 as shown in FIG. 1, and includes the following step 310.

Step 310: receive indication signaling, where the indication signaling is used to determine whether at least one band supports uplink transmission via at least two ports.

The terminal device receives the indication signaling from the network device, and determines whether the at least one band supports the uplink transmission via the at least two ports. For example, the terminal device is configured with two ports of antenna A and antenna B, and the antenna A and antenna B target a band A at the same time. The indication signaling indicates that the band supports uplink transmission via two ports or does not support uplink transmission via two ports.

For example, the terminal device receives the indication signaling, and determines, based on the indication signaling, whether the at least one band supports the uplink transmission via the at least two ports. The indication signaling is transmitted by the network device. For example, the indication signaling is at least one of Radio Resource Control (RRC) signaling, a Media Access Control Control Element (MAC CE), or Downlink Control Information (DCI).

The method for determining whether at least one band supports uplink transmission via at least two ports includes at least three manners.

Manner I is based on priority authority. Determine, through the priority authority, whether the at least one band supports the uplink transmission via the at least two ports. For example, a band with a high priority is set to support the uplink transmission via the at least two ports, and a band with a low priority is set not to support the uplink transmission via the at least two ports. The priority authority merely make a distinction between two states, including but not limited to other description modes, for example, two-port enable.

Manner II is based on a bit indicating a port. One bit corresponds to one band. This accurately indicates whether any band supports the uplink transmission via the at least two ports.

Alternatively, a value of the bit is 1 or 0, the value of the bit is used to indicate whether the any band supports the uplink transmission via the at least two ports or does not support uplink transmission via two ports.

Manner III is based on a maximum value. Determine, based on a maximum capability value of the terminal device, whether a band can support uplink transmission via the two ports.

In the embodiment, by receiving the indication signaling, whether the at least one band supports the uplink transmission via the at least two ports is determined. The implementation complexity of the UE is reduced and a balance between complexity and switching flexibility is achieved.

### Embodiment for Manner I (a Determination Manner Based on Priority Authority)

FIG. 4 shows a flowchart of a method for determining band information provided in an example of the present disclosure. For example, the method is performed by the terminal device 110 as shown in FIG. 1, and includes the following step 311.

Step 311: receive first indication signaling, where the first indication signaling is used to indicate a priority of at least one band.

In some embodiments, the first indication signaling may also be referred to as priority indication signaling.

For example, the first indication signaling is received by the terminal device, where the first indication signaling is used to indicate the priority of the at least one band. The priority of each band is defined or configured by the terminal according to at least one band supported by the terminal, and a band with first priority and a band with second priority are distinguished. The first priority is higher than the second priority. The band with the first priority supports the uplink transmission via the at least two ports, and the band with the second priority does not support the uplink transmission via the at least two ports.

For example, the terminal device receives indication signaling, and determines, based on the indication signaling, whether the at least one band supports uplink transmission via the at least two ports. The indication signaling is transmitted by the network device.

The indication signaling in the embodiments of the present disclosure is RRC signaling, a MAC CE, DCI, or a combination of at least two pieces of signaling. It is not limited in the embodiments of the present disclosure.

For example, the terminal device expects that each band configured with the first priority supports the uplink transmission via the at least two ports, and that each band configured with the second priority does not support the uplink transmission via the at least two ports.

In some embodiments, the terminal notifies the network device of transmitting the indication signaling by reporting capability information in advance or transmitting uplink control information. The terminal expects to determine, through the received indication signaling, whether the at least one band supports uplink transmission via two ports.

In the embodiment, according to the method for receiving the first indication signaling, the priority of the at least one band is indicated, and whether the at least one band supports the uplink transmission via the at least two ports is determined by distinguishing the priority.

### Embodiment for Manner II (a Determination Manner Based on a Bit Indicating a Port)

FIG. 5 shows a flowchart of a method for determining band information provided in an example of the present disclosure. For example, the method is performed by the terminal device 110 as shown in FIG. 1, and includes the following step 312.

Step 312: receive second indication signaling, where the second indication signaling is used to indicate whether at least one band supports uplink transmission via at least two ports.

In some embodiments, the second indication signaling may also be referred to as port indication signaling.

For example, the terminal device receives the second indication signaling transmitted by the network device. Each bit corresponds to one band. This can accurately indicate whether any band supports the uplink transmission via the at least two ports.

For example, there are two cases that one bit corresponds to one band.

In some embodiments, the second indication signaling carries one bit, where the bit corresponds to all bands supported by all terminal devices. The bands corresponding to the bit support uplink transmission via two ports in a case where a value of the bit is a first value; and the bands corresponding to the bit do not support the uplink transmission via the two ports in a case where the value of the bit is a second value. For example, a terminal device supports 4 bands, then the bit corresponds to all the 4 bands. It indicates that the corresponding 4 bands support the uplink transmission via the two ports in a case where the first value is 1; and it indicates that the corresponding 4 bands do not support the uplink transmission via the two ports in a case where the second value is 0.

In some embodiments, the second indication signaling carries a bitmap, where one bit in the bitmap corresponds to one band. It indicates that the band corresponding to the bit supports uplink transmission via two ports in a case where the value of the bit is a first value; and it indicates that the band corresponding to the bit does not support the uplink transmission via the two ports in a case where the value of the bit is a second value.

For example, the second indication signaling carries a bitmap, where one bit in the bitmap corresponds to one band. For example, the bitmap includes 4 bits, then the 4 bits respectively correspond to 4 bands. It indicates that the corresponding band supports uplink transmission via two ports in a case where the first value is 1; and the corresponding band does not support the uplink transmission via the two ports in a case where the second value is 0.

For example, a quantity of bits in the bitmap is a first value N, where N is a maximum quantity of bands. That is, the bitmap includes N bits, where N is a quantity of uplink bands/band pairs supported by the terminal device, a quantity of uplink bands/band pairs configured by the network device, or a preset value.

Assume that N is a preset value. In a case where a band value n1 indicated by the network device or reported by the terminal device, is less than the first value N, n1 high-order bits in the bitmap are valid bits, n1 being less than N; or in a case where a band value n2 indicated by the network device or reported by the terminal device, is less than the first value N, n2 low-order bits in the bitmap are valid bits, n2 being less than N.

For example, the terminal device receives indication signaling, and determines, based on the indication signaling, whether the at least one band supports uplink transmission via at least two ports. The indication signaling is transmitted by the network device.

The indication signaling in the embodiments of the present disclosure is RRC signaling, a MAC CE, DCI, or a combination of at least two pieces of signaling. It is not limited in the embodiments of the present disclosure.

In some embodiments, the terminal notifies the network device of transmitting the indication signaling by reporting capability information in advance or transmitting uplink control information. The terminal expects to determine, through the received indication signaling, whether the at least one band supports uplink transmission via two ports.

In the embodiment, according to the method for receiving the second indication signaling, a bit indicating a port is defined. One bit corresponds to all ports of the terminal device, or one bit value corresponds to one port. This can accurately indicate whether any band supports the uplink transmission via the at least two ports.

### Embodiment for Manner III (a Determination Manner Based on a Maximum Value)

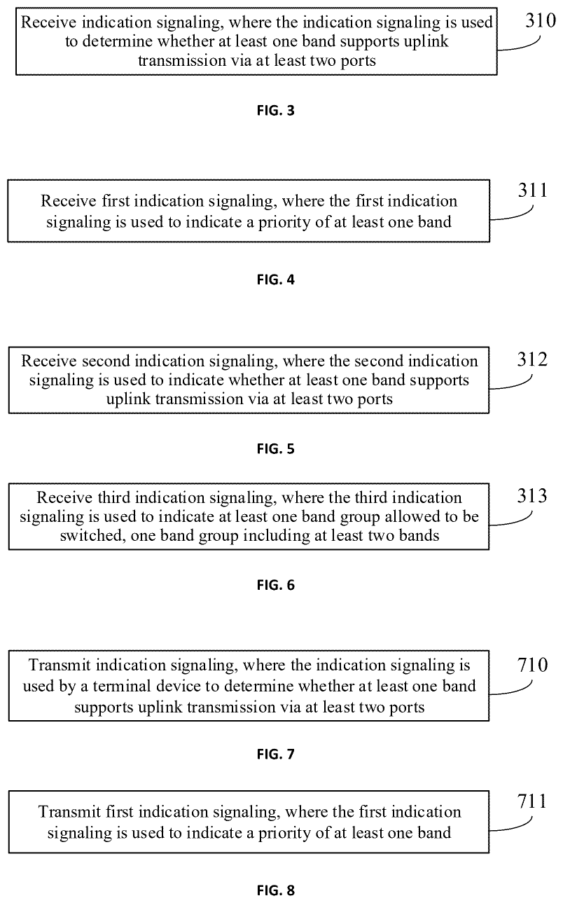

FIG. 6 shows a flowchart of a method for determining band information provided in an example of the present disclosure. For example, the method is performed by the terminal device 110 as shown in FIG. 1 and includes the following step 313.

Step 313: receive third indication signaling, where the third indication signaling is used to indicate at least one band group allowed to be switched, one band group including at least two bands.

In some embodiments, the third indication signaling may further be referred to as maximum value indication signaling. The terminal device reports a maximum value M of bands supporting transmission via two ports, and determines, by defining band group indication signaling, a band group can be switched by the terminal device. In a case where a quantity of bands in the at least one band group is not greater than a maximum value M, all bands in the at least one band group support uplink transmission via two ports; and in a case where the quantity of the bands in the at least one band group is greater than the maximum value M, M bands in the at least one band group support uplink transmission via two ports.

For example, the maximum value M of the bands supporting the transmission via the two ports reported by the terminal device is set to 10. If the quantity of bands in the at least one band group is not greater than 10, for example, the quantity of the bands is 5 or 10, all the bands in the at least one band group support uplink transmission via two ports; if the quantity of the bands in the at least one band group is greater than 10, for example, the quantity of the bands is 11 or 20, 10 bands in the at least one band group support the uplink transmission via the two ports while the remaining 1 or the remaining 10 bands do not support the uplink transmission via the two ports.

In some embodiments, the M bands are first M bands in a predetermined order in the at least one band group. For example, in a band group abcd, band a, band b, and band c support the uplink transmission via the two ports.

In some embodiments, the M bands are last M bands in a predetermined order in the at least one band group. For example, in a band group abcd, band b, band c, and band d support the uplink transmission via the two ports.

For example, the predetermined order is any one of a descending order of frequencies, an ascending order of frequencies, an ascending order of indexes of band, or a descending order of indexes of bands.

For example, the terminal device receives indication signaling, and determines, based on the indication signaling, whether the at least one band supports the uplink transmission via the at least two ports. The indication signaling is transmitted by the network device.

The indication signaling in the embodiments of the present disclosure is RRC signaling, a MAC CE, DCI, or a combination of at least two pieces of signaling. It is not limited in the embodiments of the present disclosure.

In some embodiments, the terminal device reports a maximum value M to the network device in advance, where the maximum value M is used to indicate a maximum quantity of bands that the terminal device supports uplink concurrent transmission. In some embodiments, the maximum value M is configured by the network device, or predefined in a protocol.

In some embodiments, the terminal notifies the network device of transmitting the indication signaling by reporting capability information in advance or transmitting uplink control information. The terminal expects to determine, through the received indication signaling, whether the at least one band supports the uplink transmission via the two ports.

In the embodiment, according to the method for receiving the third indication signaling, whether the band supports the uplink transmission via the at least two ports is determined based on the maximum value M reported by the terminal device.

FIG. 7 shows a flowchart of a method for determining band information provided in an example of the present disclosure. For example, the method is performed by the network device 120 as shown in FIG. 1, and includes the following step 710.

Step 710: transmit indication signaling, where the indication signaling is used by a terminal device to determine whether at least one band supports uplink transmission via at least two ports.

The indication signaling is transmitted by the network device to the terminal device, and whether the at least one band supports the uplink transmission via the at least two ports is determined by the terminal device. For example, the terminal device is configured with two ports of antennas A and antenna B, and the antenna A and antenna B target a band A at the same time. The indication signaling indicates that the band supports the uplink transmission via the two ports or does not support the uplink transmission via the two ports.

For example, the indication signaling is transmitted by the network device, and whether the at least one band supports the uplink transmission via the at least two ports is determined by the terminal device based on the indication signaling.

The indication signaling in the embodiments of the present disclosure is RRC signaling, a MAC CE, DCI, or a combination of at least two pieces of signaling. It is not limited in the embodiments of the present disclosure.

The method for determining whether at least one band supports uplink transmission via at least two ports includes at least three manners.

Manner I is based on priority authority. Determine, through the priority authority, whether the at least one band supports the uplink transmission via the at least two ports. For example, a band with a high priority is set to support the uplink transmission via the at least two ports, and a band with a low priority is set not to support the uplink transmission via the at least two ports. The priority authority merely make a distinction between two states, including but not limited to other description modes, for example, two-port enable.

Manner II is based on a port indication bit. Each bit corresponds to one band. This accurately indicates whether any band supports the uplink transmission via the at least two ports.

Alternatively, a value of the bit is 1 or 0, the value of the bit is used to indicate whether any band supports the uplink transmission via the at least two ports or does not support uplink transmission via two ports.

Manner III is based on a maximum value. Determine, through the maximum capability value of the terminal device, whether the band can support the uplink transmission via the two ports.

In the embodiment, whether the at least one band supports the uplink transmission via the at least two ports is determined by transmitting the indication signaling. The implementation complexity of the UE is reduced and a balance between complexity and switching flexibility is achieved.

### Embodiment for Manner I (a Determination Manner Based on Priority Authority)

FIG. 8 shows a flowchart of a method for determining band information provided in an example of the present disclosure. For example, the method is performed by the network device 120 as shown in FIG. 1 and includes the following step 711.

Step 711: transmit first indication signaling, where the first indication signaling is used to indicate a priority of at least one band.

For example, the first indication signaling is transmitted by the network device, where the first indication signaling is used to indicate the priority of at least one band. The priority of each band is defined or configured by the terminal according to at least one band supported by the terminal, and a band with a first priority and a band with a second priority are distinguished. The first priority is higher than the second priority. The band with the first priority supports the uplink transmission via the at least two ports, and the band with the second priority does not support the uplink transmission via the at least two ports.

For example, the network device transmits indication signaling, and determines, based on the indication signaling, whether the at least one band supports uplink transmission via the at least two ports. The indication signaling is transmitted by the network device.

The indication signaling in the embodiments of the present disclosure is RRC signaling, a MAC CE, DCI, or a combination of at least two pieces of signaling. It is not limited in the embodiments of the present disclosure.

For example, the terminal device expects that each band configured with the first priority supports the uplink transmission via the at least two ports, and that each band configured with the second priority does not support the uplink transmission via the at least two ports.

In some embodiments, the network device receives capability information reported from the terminal device, or uplink control information transmitted by the terminal device, and the network device transmits the indication signaling based on the information. The terminal determines whether the at least one band supports uplink transmission via two ports through the received indication signaling.

In the embodiment, according to the method for transmitting the first indication signaling, the priority of the at least one band is indicated, and whether the at least one band supports the uplink transmission via the at least two ports is determined by distinguishing the priority.

### Embodiment for Manner II (a Determination Manner Based on a Bit Indicating a Port)

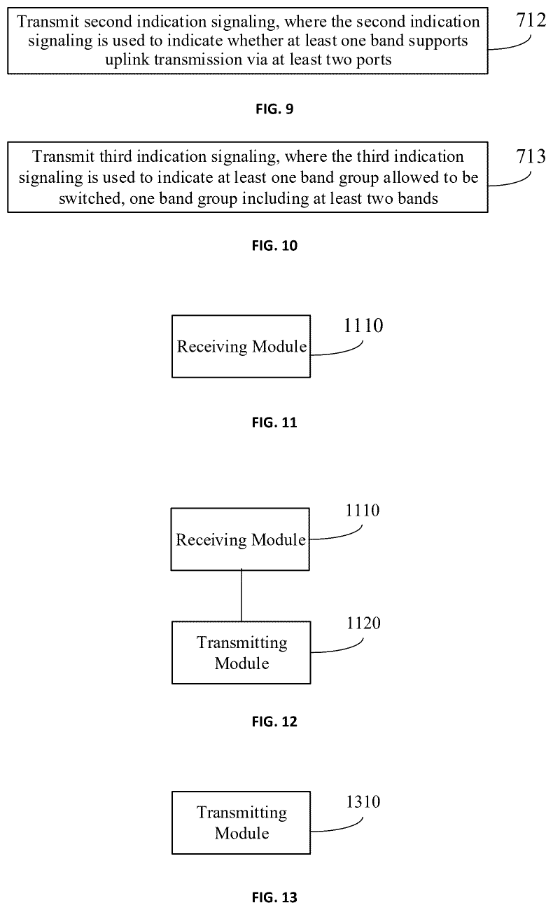

FIG. 9 shows a flowchart of a method for determining band information provided in an example of the present disclosure. For example, the method is performed by the network device 120 as shown in FIG. 1 and includes the following step 712.

Step 712: transmit second indication signaling, where the second indication signaling is used to indicate whether at least one band supports uplink transmission via at least two ports.

For example, the port indication signaling is defined. The network device transmits the second indication signaling to the terminal device. Each bit corresponds to one band. This can accurately indicate whether any band supports the uplink transmission via the at least two ports.

For example, there are two cases that one bit corresponds to one band.

In some embodiments, the second indication signaling carries one bit, where the bit corresponds to all bands supported by all terminal devices. It indicates that the bands corresponding to the bit support uplink transmission via two ports in a case where a value of the bit is a first value; and it indicates that the bands corresponding to the bit do not support the uplink transmission via the two ports in a case where the value of the bit is a second value. For example, a terminal device supports 4 bands, then the bit corresponds to all the 4 bands. It indicates that the corresponding 4 bands support uplink transmission via two ports in a case where the first value is 1; and it indicates that the corresponding 4 bands do not support the uplink transmission via the two ports in a case where the second value is 0.

In some embodiments, the second indication signaling carries a bitmap, where one bit in the bitmap corresponds to one band. It indicates that the band corresponding to the bit supports uplink transmission via two ports in a case where the value of the bit is a first value; and it indicates that the band corresponding to the bit does not support the uplink transmission via the two ports in a case where the value of the bit is a second value.

For example, the second indication signaling carries a bitmap, where one bit in the bitmap corresponds to one band. For example, the bitmap includes 4 bits, then the 4 bits respectively correspond to 4 bands. It indicates that the corresponding band supports uplink transmission via two ports in a case where the first value is 1; and it indicates that the corresponding band does not support the uplink transmission via the two ports in a case where the second value is 0.

For example, a quantity of bits in the bitmap is a first value N, where N is a maximum quantity of bands. That is, the bitmap includes N bits, where N is a quantity of uplink bands/band pairs supported by the terminal device, a quantity of uplink bands/band pairs configured by the network device, or a preset value.

Assume that N is a preset value, in a case where a band value n1 indicated by the network device or reported by the terminal device, is less than the first value N, n1 high-order bits in the bitmap are valid bits, n1 being less than N; or in a case where a band value n2 indicated by the network device or reported by the terminal device, is less than the first value N, n2 low-order bits in the bitmap are valid bits, n2 being less than N.

For example, the terminal device receives indication signaling, and determines, based on the indication signaling, whether at least one band supports the uplink transmission via the at least two ports. The indication signaling is transmitted by the network device.

The indication signaling in the embodiments of the present disclosure is RRC signaling, a MAC CE, DCI, or a combination of at least two pieces of signaling. It is not limited in the embodiments of the present disclosure.

In some embodiments, the network device receives capability information reported from the terminal device, or uplink control information transmitted by the terminal device, and the network device transmits the indication signaling based on the information. The terminal determines whether the at least one band supports uplink transmission via two ports through the received indication signaling.

In the embodiment, according to the method for transmitting the second indication signaling, the bit indicating a port is defined. One bit corresponds to all ports of the terminal device, or each bit value corresponds to one port. This can accurately indicate whether any band supports the uplink transmission via the at least two ports.

### Embodiment for Manner III (a Determination Manner Based on a Maximum Value)

FIG. 10 shows a flowchart of a method for determining band information provided in an example of the present disclosure. For example, the method is performed by the network device 120 as shown in FIG. 1 and includes the following step 713.

Step 713: transmit third indication signaling, where the third indication signaling is used to indicate at least one band group allowed to be switched, one band group including at least two bands.

The network device receives a maximum value M of bands supporting transmission via two ports, and determines, by defining band group indication signaling, a band group can be switched by the terminal device. In a case where a quantity of bands in at least one band group is not greater than the maximum value M, all the bands in the at least one band group support uplink transmission via two ports; and in a case where the quantity of the bands in the at least one band group is greater than the maximum value M, M bands in the at least one band group support the uplink transmission via the two ports.

For example, the maximum value M of the bands supporting transmission via two ports received by the network device is set to 10. If the quantity of the bands in the at least one band group is not greater than 10, for example, the quantity of the bands is 5 or 10, all the bands in the at least one band group support the uplink transmission via the two ports; if the quantity of bands in the at least one band group is greater than 10, for example, the quantity of the bands is 11 or 20, 10 bands in the at least one band group support the uplink transmission via the two ports while the remaining 1 or the remaining 10 bands do not support the uplink transmission via the two ports.

In some embodiments, the M bands are first M bands in a predetermined order in the at least one band group. For example, in a band group abcd, band a, band b, and band c support the uplink transmission via the two ports.

In some embodiments, the M bands are last M bands in a predetermined order in the at least one band group. For example, in a band group abcd, band b, band c, and band d support the uplink transmission via the two ports.

For example, the predetermined order is any one of a descending order of frequencies, an ascending order of frequencies, an ascending order of indexes of band, or a descending order of indexes of bands.

For example, the indication signaling is transmitted by the network device, and whether the at least one band supports the uplink transmission via the at least two ports is determined by the terminal device based on the indication signaling.

The indication signaling in the embodiments of the present disclosure is RRC signaling, a MAC CE, DCI, or a combination of at least two pieces of signaling. It is not limited in the embodiments of the present disclosure.

In some embodiments, the network device receives capability information reported from the terminal device, or uplink control information transmitted by the terminal device, and the network device transmits the indication signaling based on the information. The terminal determines whether the at least one band supports the uplink transmission via the two ports through the received indication signaling.

In the embodiment, according to the method for transmitting the third indication signaling, whether the band supports the uplink transmission via the at least two ports is determined based on the maximum value M received by the network device.

FIG. 11 shows a block diagram of a device for determining band information provided in an example of the present disclosure. The device may be implemented as a terminal device via software or hardware. The device includes a receiving module 1110.

The receiving module 1110, configured to determine whether at least one band supports uplink transmission via at least two ports.

The receiving module 1110 is configured to receive first indication signaling, where the first indication signaling is used to indicate a priority of the at least one band.

For example, the first indication signaling is used to indicate the priority of the at least one band. The priority of each band is defined or configured by the terminal according to at least one band supported by the terminal, and a band with a first priority and a band with a second priority are distinguished. The first priority is higher than the second priority. The band with the first priority supports the uplink transmission via the at least two ports, and the band with the second priority does not support the uplink transmission via the at least two ports.

For example, the terminal device expects that each band configured with the first priority supports the uplink transmission via the at least two ports, and that each band configured with the second priority does not support the uplink transmission via the at least two ports.

The receiving module 1110 is configured to receive second indication signaling, where the second indication signaling is used to indicate whether the at least one band supports the uplink transmission via the at least two ports.

For example, the second indication signaling carries a bit, where the bit corresponds to all bands supported by all terminal devices. It indicates that the bands corresponding to the bit support uplink transmission via two ports in a case where a value of the bit is a first value; and it indicates that the bands corresponding to the bit do not support the uplink transmission via the two ports in a case where the value of the bit is a second value.

In some embodiments, the second indication signaling carries a bit, where the bit corresponds to all bands supported by all terminal devices. For example, the terminal device supports 4 bands, then the bit corresponds to all the 4 bands. It indicates that the corresponding 4 bands support the uplink transmission via the two ports in a case where the value of the bit is 1; and it indicates that the corresponding 4 bands do not support the uplink transmission via the two ports in a case where the value of the bit is 0.

For example, the second indication signaling carries a bitmap, where one bit in the bitmap corresponds to one band. It indicates that the band corresponding to the bit supports the uplink transmission via the two ports in a case where the value of the bit is a first value; and it indicates that the band corresponding to the bit does not support the uplink transmission via the two ports in a case where the value of the bit is a second value.

In some embodiments, the second indication signaling carries a bitmap, where one bit in the bitmap corresponds to one band. For example, the bitmap includes 5 bits, then the 5 bits respectively correspond to 5 bands. It indicates that the corresponding band supports the uplink transmission via the two ports in a case where a value of a certain bit is 1; and it indicates that the corresponding band does not support the uplink transmission via the two ports in a case where the value of the certain bit is 0.

For example, a quantity of bits in the bitmap is a first value N, where N is a maximum quantity of bands. In a case where a band value n1 indicated by the network device or reported by the terminal device, is less than the first value N, n1 high-order bits in the bitmap are valid bits, n1 being less than N; or
in a case where a band value n2 indicated by the network device or reported by the terminal device, is less than the first value N, n2 low-order bits in the bitmap are valid bits, n2 being less than N.

The receiving module 1110 is configured to receive third indication signaling, where the third indication signaling is used to indicate at least one band group allowed to be switched, one band group including at least two bands.

For example, with reference to FIG. 12, the device further includes:
a transmitting module 1120, configured to report a maximum value M, where the maximum value M is used to indicate a maximum quantity of the bands that the terminal supports the uplink transmission via the two ports.

For example, the terminal device reports a maximum value M of bands supporting transmission via two ports, and determines, by defining band group indication signaling, a band group can be switched by the terminal device. In a case where a quantity of bands in the at least one band group is not greater than the maximum value M, all bands in the at least one band group support the uplink transmission via the two ports; and in a case where the quantity of bands in the at least one band group is greater than the maximum value M, M bands in the at least one band group support uplink transmission via two ports.

In some embodiments, the maximum quantity of the bands supporting transmission via two ports reported by the terminal device is set to 10. If the quantity of bands in the at least one band group is not greater than 10, for example, the quantity of the bands is 5 or 10, all bands in the at least one band group support uplink transmission via two ports; if the quantity of bands of at least one band group is greater than 10, for example, the quantity of the bands is 11 or 20, 10 bands in the at least one band group support the uplink transmission via the two ports while the remaining 1 or the remaining 10 bands do not support the uplink transmission via the two ports.

For example, the indication signaling is transmitted by the network device. The receiving module 1110 receives the indication signaling, and determines, based on the indication signaling, whether the at least one band supports uplink transmission via at least two ports.

The indication signaling in the embodiments of the present disclosure is RRC signaling, a MAC CE, DCI, or a combination of at least two pieces of signaling. It is not limited in the embodiments of the present disclosure.

FIG. 13 shows a block diagram of a device for determining band information provided in an example of the present disclosure. The device includes a transmitting module 1310.

The transmitting module 1310, configured to transmit indication signaling, where the indication signaling is used by a terminal device to determine whether at least one band supports uplink transmission via at least two ports.

The transmitting module 1310 is configured to transmit first indication signaling, where the first indication signaling is used to indicate a priority of the at least one band.

For example, the first indication signaling is used to indicate the priority of the at least one band. The priority of each band is defined or configured by the terminal according to at least one band supported by the terminal, and a band with a first priority and a band with a second priority are distinguished. The first priority is higher than the second priority. The band with the first priority supports the uplink transmission via the at least two ports, and the band with the second priority does not support the uplink transmission via the at least two ports.

For example, the terminal device expects that each band configured with the first priority supports the uplink transmission via the at least two ports, and that each band configured with the second priority does not support the uplink transmission via the at least two ports.

The transmitting module 1310 is configured to transmit second indication signaling, where the second indication signaling is used to indicate whether the at least one band supports the uplink transmission via the at least two ports.

For example, the second indication signaling carries a bit, where the bit corresponds to all bands supported by all terminal devices. It indicates that the bands corresponding to the bit support uplink transmission via two ports in a case where a value of the bit is a first value; and it indicates that the bands corresponding to the bit do not support the uplink transmission via the two ports in a case where the value of the bit is a second value.

In some embodiments, the second indication signaling carries one bit, where the bit corresponds to all bands supported by all terminal devices. For example, the terminal device supports 4 bands, then the bit corresponds to all the 4 bands. It indicates that the corresponding 4 bands support uplink transmission via two ports in a case where the value of the bit is 1; and the corresponding 4 bands do not support the uplink transmission via the two ports in a case where the value of the bit is 0.

For example, the second indication signaling carries a bitmap, where one bit in the bitmap corresponds to one band. It indicates that the band corresponding to the bit supports uplink transmission via two ports in a case where the value of the bit is a first value; and it indicates that the band corresponding to the bit does not support the uplink transmission via the two ports in a case where the value of the bit is a second value.

In some embodiments, the second indication signaling carries a bitmap, where one bit in the bitmap corresponds to one band. For example, the bitmap includes 4 bits, then the 4 bits respectively correspond to 4 bands. It indicates that the corresponding band supports the uplink transmission via the two ports in a case where a value of a certain bit is 1; and it indicates that the corresponding band does not support the uplink transmission via the two ports in a case where the value of the certain bit is 0.

For example, a quantity of bits in the bitmap is a first value N, where N is a maximum quantity of bands. In a case where a band value n1 indicated by the network device or reported by the terminal device, is less than the first value N, n1 high-order bits in the bitmap are valid bits, n1 being less than N; or
in a case where a band value n2 indicated by the network device or reported by the terminal device, is less than the first value N, n2 low-order bits in the bitmap are valid bits, n2 being less than N.

The transmitting module 1310 is configured to transmit third indication signaling, where the third indication signaling is used to indicate at least one band group allowed to be switched, one band group including at least two bands.

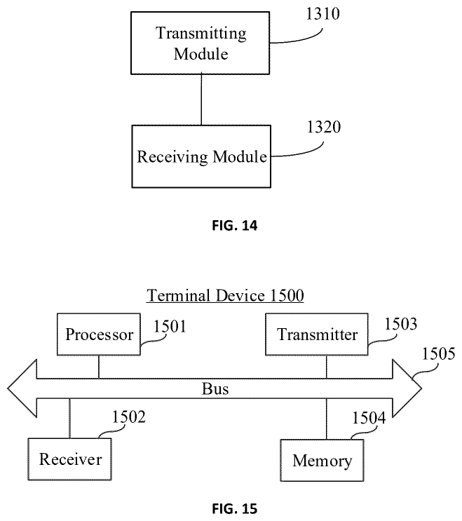

For example, with reference to FIG. 14, the device further includes:
a receiving module 1320, configured to receive a maximum value M, where the maximum value M is used to indicate a maximum quantity of the bands that the terminal supports uplink transmission via two ports.

For example, the network device receives a maximum value M of bands supporting transmission via two ports, and determines, by defining band group indication signaling, a band group can be switched by the terminal device. In a case where a quantity of bands in at least one band group is not greater than the maximum value M, all bands in the at least one band group support the uplink transmission via the two ports; and in a case where the quantity of the bands in the at least one band group is greater than the maximum value M, M bands in the at least one band group support the uplink transmission via the two ports.

In some embodiments, the maximum quantity of the bands supporting the transmission via the two ports received by the network device is set to 10. If the quantity of bands in the at least one band group is not greater than 10, for example, the quantity of the bands is 5 or 10, all bands in the at least one band group support uplink transmission via two ports; if the quantity of bands in the at least one band group is greater than 10, for example, the quantity of the bands is 11 or 20, 10 bands in the at least one band group support uplink transmission via two ports while the remaining 1 or the remaining 10 bands do not support the uplink transmission via the two ports.

For example, the indication signaling is transmitted by the network device, and whether the at least one band supports uplink transmission via the at least two ports is determined based on the indication signaling.

The indication signaling in the embodiments of the present disclosure is RRC signaling, a MAC CE, DCI, or a combination of at least two pieces of signaling. It is not limited in the embodiments of the present disclosure.

According to an aspect of the present disclosure, a method for determining band information is provided. The method is performed by a terminal device, and includes: receiving indication signaling, where the indication signaling is used to determine whether at least one band supports uplink transmission via at least two ports.

According to an aspect of the present disclosure, a method for determining band information is provided. The method is performed by a network device, and includes: transmitting indication signaling, where the indication signaling is used to determine whether at least one band supports uplink transmission via at least two ports.

According to an aspect of the present disclosure, a device for determining band information is provided. The device includes: a receiving module, configured to receive indication signaling, where the indication signaling is used to determine whether at least one band supports uplink transmission via at least two ports.

According to an aspect of the present disclosure, a device for determining band information is provided. The device includes: a transmitting module, configured to transmit indication signaling, where the indication signaling is used to determine whether at least one band supports uplink transmission via at least two ports.

According to an aspect of the present disclosure, a terminal device is provided. The terminal device includes: one or more processors; and a transceiver connected to the one or more processors; where the one or more processors are collectively configured to load and execute executable instructions to perform the method for determining band information as described in the aspects

According to an aspect of the present disclosure, a network device is provided. The network device includes: one or more processors; and a transceiver connected to the one or more processors; where the one or more processors are collectively configured to load and execute executable instructions to perform the method for determining band information as described in the aspects.

According to an aspect of the present disclosure, a non-transitory computer-readable storage medium is provided. The non-transitory computer-readable storage medium stores at least one instruction, at least one program, a code set or an instruction set, when loaded and executed by one or more processors, implements the method for determining band information as described in the aspects.

According to an aspect of the present disclosure, a computer program product is provided. The computer program product includes computer instructions stored in a computer-readable storage medium. A processor of a computer device reads the computer instructions from the computer-readable storage medium and executes the computer instructions, causing the computer device to perform the method for determining band information as described in the aspects.

The technical solutions provided in the embodiments of the present disclosure at least include the following beneficial effects.

A terminal device receives indication signaling, and determines, based on the indication signaling, whether the at least one band supports the uplink transmission via the at least two ports. This enables the terminal device in an Uplink Tx Switching scenario to determine which bands support uplink transmission via the at least two ports and which bands do not. A network device can limit a part of bands to support uplink transmission via at least two ports according to the terminal capability. Implementation complexity of the terminal device is reduced and a balance between complexity and switching flexibility are achieved.

FIG. 15 shows a block diagram of a terminal device 1500 provided in an example of the present disclosure. The terminal device 1500 includes: a processor 1501, a receiver 1502, a transmitter 1503, a memory 1504, and a bus 1505.

The processor 1501 includes one or more processing cores. The processor 1501 performs, by running a software program and a module, various functional applications and information processing.

The receiver 1502 and the transmitter 1503 may be implemented as one communication component. The communication component may be one communication chip.

The memory 1504 is connected, via the bus 1505, to the processor 1501.

The memory 1504 may be configured to store at least one instruction. The processor 1501 may be configured to implement, by performing the at least one instruction, various steps in the method embodiments.

In addition, the memory 1504 may be implemented by any type of volatile and non-volatile memory devices or their combinations. The volatile and non-volatile memory devices include but are not limited to, a magnetic or optical disk, an Electrically Erasable Programmable Read Only Memory (EEPROM), an Erasable Programmable Read Only Memory (EPROM), a Static Random-Access Memory (SRAM), a Read Only Memory (ROM), a magnetic memory, a flash memory, and a Programmable Read Only Memory (PROM).

In an example, a non-transitory readable storage medium including instructions, for example, a memory including instructions is further provided. The instructions are executable by a processor of a terminal to complete the method for determining band information. For example, the non-transitory readable storage medium may be a ROM, a Random-Access Memory (RAM), a Compact Disc Read Only Memory (CD-ROM), a magnetic tape, a floppy disk and an optical data storage device, and the like.

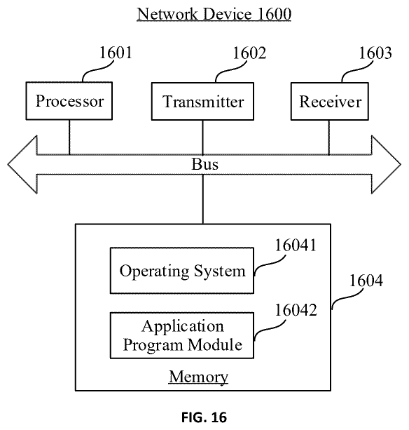

FIG. 16 is a block diagram of a network device 1600 shown according to an example. The network device 1600 may be a base station.

The network device 1600 may include a processor 1601, a receiver 1602, a transmitter 1603, and a memory 1604. The receiver 1602, the transmitter 1603, and the memory 1604 are respectively connected to the processor 1601 via a bus.

The processor 1601 includes one or more processing cores. The processor 1601 performs, by running a software program and a module, the method for determining band information provided in the embodiments of the present disclosure. The memory 1604 may be configured to store a software program and a module. For example, the memory 1604 may store an operating system 16041, an application program module 16042 needed for at least one function. The receiver 1602 is configured to receive communication data transmitted by other devices. The transmitter 1603 is configured to transmit communication data to other devices.

A computer-readable storage medium is further provided in an example of the present disclosure. At least one program is stored in the computer-readable storage medium. The at least one program is loaded and executed by a processor to implement the method for determining band information provided in the method embodiments.

A computer program product is further provided in an example of the present disclosure. The computer program product includes at least one program. The at least one program is stored in a readable storage medium. A processor of a communication device reads signaling from the readable storage medium. The processor executes the signaling, causing the communication device to perform the method for determining band information provided in the method embodiments.

A computer program is further provided in an example of the present disclosure. The computer program includes at least one program stored in a computer-readable storage medium. A processor of a communication device reads the at least one program from the computer-readable storage medium. The processor executes the at least one program, causing the communication device to perform the method for determining band information provided in the method embodiment.

A system and method for reporting a preparation time of uplink antenna switching are further provided in an example of the present disclosure.
1. A terminal notifies a base station of a first preparation time, and alternatively, a terminal or/and a base station defaults to a first preparation time.
2. Based on 1, the terminal reports a value of the first preparation time to the base station by reporting terminal capability.
3. Based on 1, the terminal transmits first signaling to the base station before antenna switching, where the first signaling includes a value of the first preparation time.
4. Based on 1, the base station or/and the terminal defaults a first time to a first preparation time.
5. Based on 1, the first preparation time is defined as a time needed for the terminal to conduct memory cell refreshing/loading.
6. Based on 1, the first preparation time is defined as a time for the terminal to interrupt all current transmissions.
7. Based on 1, the first preparation time is defined as a time for the base station to stop scheduling the terminal.
8. Based on 1, the terminal expects that the base station interrupts the scheduling of the terminal in the first preparation time.
9. Based on 1, the terminal expects that the base station interrupts the scheduling of the terminal in the first preparation time+a second preparation time, where the second preparation time is a time needed for the terminal to switch antennas.
10. Based on 2, 3, or 4, an effective condition of the first preparation time includes but is not limited to at least one of: a switching pattern involving two or more bands, or uplink antenna switching occurring between different switching cases.
11. Based on 7 or 8, the base station interrupting the scheduling of the terminal includes but is not limited to:
the terminal stopping transmitting any transmission;
the terminal stopping receiving any transmission transmitted by the base station;
the base station stopping transmitting any transmission to the terminal, and the base station stopping receiving any transmission transmitted by the terminal.
12. Based on 10, the switching pattern includes but is not limited to at least one of:
switching between 2 single-port UL bands and another 2 single-port UL bands;
switching between 2 single-port UL bands and another 1 single-port UL band;
switching between 2 single-port UL bands and another 1 two-port UL band;
switching between 2 single-port UL bands and 1 single-port UL band thereof;
switching between 2 single-port UL bands and 1 two-port UL band thereof;
switching between 1 single-port UL band and another 1 single-port UL band;
switching between 1 two-port UL band and another 1 two-port UL band; or
before switching, a state of a first port is in a first band, and a second port is in a pre-stored state of a second band; after switching, a state of at least one port is in a third band.
13. Based on 10, the switching cases include but are not limited to at least one of:
the terminal supporting three bands, where a first antenna targets a first band, and a second antenna targets a second band;
the terminal supporting four bands, where a first antenna targets a first band, and a second antenna targets a second band;
the terminal supporting three bands, where a first antenna and a second antenna target a first band; or
the terminal supporting four bands, where a first antenna and a second antenna target a first band.
14. Based on 3, the first time is determined by at least one of:
being predefined in a protocol;
being configured, to the terminal, by the base station via semi-static signaling;
being notified, of the terminal, by the base station via a MAC CE; or
being notified, of the terminal, by the base station via DCI.
15. Based on 3, a form of the first signaling is determined by at least one of:
being transmitted by the terminal via a Physical Uplink Shared Channel (PUSCH);
being transmitted by the terminal via a Physical Uplink Control Channel (PUCCH); or
Uplink Control Information (UCI).

It is to be understood that “a plurality of” as mentioned herein refers to two or more. Those skilled in the art will readily envisage other implementation solutions of the present disclosure after consideration of the specification and practice of the disclosure disclosed herein. The present disclosure is intended to cover any variations, uses, or adaptations of the present disclosure that follow the general principles of the present disclosure and include common general knowledge or customary technical means in the technical field that are not disclosed in the present disclosure. The specification and the embodiments are merely regarded to be illustrative, and the true scope and spirit of the present disclosure is indicated by the following claims.

It is to be understood that the present disclosure is not limited to the precise constructions which have been described and shown in the accompanying drawings, and that various modifications and changes may be made without departing from the scope of the present disclosure. The scope of the present disclosure is limited merely by the appended claims.

1. A method for determining band information, performed by a terminal device, comprising:
receiving indication signaling, wherein the indication signaling is used to determine whether at least one band supports uplink transmission via at least two ports.

2. The method according to claim 1, wherein receiving the indication signaling comprises:
receiving first indication signaling, wherein the first indication signaling is used to indicate a priority of the at least one band;
wherein a band with a first priority supports the uplink transmission via the at least two ports, and a band with a second priority does not support the uplink transmission via the at least two ports.

3. The method according to claim 2, wherein the first priority is higher than the second priority.

4. (canceled)

5. The method according to claim 2, wherein the terminal device is configured that each band configured with the first priority supports the uplink transmission via the at least two ports, and that each band configured with the second priority does not support the uplink transmission via the at least two ports.

6. The method according to claim 1, wherein receiving the indication signaling comprises:
receiving second indication signaling, wherein the second indication signaling is used to indicate whether the at least one band supports the uplink transmission via the at least two ports, wherein
the second indication signaling carries a bit, and the bit corresponds to all bands supported by a terminal; or the second indication signaling carries a bitmap, and one bit in the bitmap corresponds to one band.

7. (canceled)

8. The method according to claim 6, wherein the bit corresponds to all bands supported by the terminal; and wherein:
in a case where the bit is a first value, the first value indicates that a band corresponding to the bit supports uplink transmission via two ports; and
in a case where the bit is a second value, the second value indicates that a band corresponding to the bit does not support uplink transmission via two ports.

9. (canceled)

10. The method according to claim 6, wherein one bit in the bitmap corresponds to one band; and wherein:
in a case where a bit is a first value, the first value indicates that a band corresponding to the bit supports uplink transmission via two ports; and
in a case where a bit is a second value, the second value indicates that a band corresponding to the bit does not support uplink transmission via two ports.

11. The method according to claim 6, wherein a quantity of bits in the bitmap is a first value N; and wherein:
in a case where a band value n1 indicated by a network device or reported by the terminal device is less than the first value N, n1 high-order bits in the bitmap are valid bits; and
in a case where a band value n2 indicated by a network device or reported by the terminal device is less than the first value N, n2 low-order bits in the bitmap are valid bits.

12. (canceled)

13. The method according to claim 1, wherein receiving the indication signaling comprises:
receiving third indication signaling, wherein the third indication signaling is used to indicate at least one band group allowed to be switched, one band group comprising at least two bands, and wherein
in a case where a quantity of bands in the at least one band group is not greater than a maximum value M, all bands in the at least one band group support uplink transmission via two ports; and
in a case where a quantity of the bands in the at least one band group is greater than a maximum value M, M bands in the at least one band group support uplink transmission via two ports.

14. The method according to claim 13, wherein
the M bands are first M bands in a predetermined order in the at least one band group; or
the M bands are last M bands in a predetermined order in the at least one band group;
wherein the predetermined order is any one of a descending order of frequencies, an ascending order of frequencies, an ascending order of indexes of band, or a descending order of indexes of bands.

15. (canceled)

16. (canceled)

17. A method for determining band information, performed by a network device, comprising:
transmitting indication signaling, wherein the indication signaling is used by a terminal device to determine whether at least one band supports uplink transmission via at least two ports.

18. The method according to claim 17, wherein transmitting the indication signaling comprises:
transmitting first indication signaling, wherein the first indication signaling is used to indicate a priority of the at least one band;
wherein a band with a first priority supports the uplink transmission via the at least two ports, and a band with a second priority does not support the uplink transmission via the at least two ports.

19-21. (canceled)

22. The method according to claim 17, wherein transmitting the indication signaling comprises:
transmitting second indication signaling, wherein the second indication signaling is used to indicate whether the at least one band supports the uplink transmission via the at least two ports.

23. The method according to claim 22, wherein the second indication signaling carries a bit, and the bit corresponds to all bands supported by a terminal; or,
the second indication signaling carries a bitmap, and one bit in the bitmap corresponds to one band.

24-28. (canceled)

29. The method according to claim 17, wherein transmitting the indication signaling comprises:
transmitting third indication signaling, wherein the third indication signaling is used to indicate at least one band group allowed to be switched, the one band group comprising at least two bands; wherein
in a case where a quantity of bands in the at least one band group is not greater than a maximum value M, all bands in the at least one band group support uplink transmission via two ports; and in a case where a quantity of the bands in the at least one band group is greater than a maximum value M, M bands in the at least one band group support uplink transmission via two ports.

30. (canceled)

31. The method according to claim 29, further comprising:
receiving the maximum value M, wherein the maximum value M is a maximum quantity of bands that the terminal device supports uplink transmission via two ports.

34. (canceled)

35. A terminal device, comprising:
one or more processors; and
a transceiver connected to the one or more processors;
wherein the one or more processors are collectively configured to:
receive indication signaling, wherein the indication signaling is used to determine whether at least one band supports uplink transmission via at least two ports.

36. A network device, comprising:
one or more processors; and
a transceiver connected to the one or more processors;
wherein the one or more processors is configured to load and execute executable instructions to perform the method for determining band information according to claim 17.

37. (canceled)

38. A non-transitory computer-readable storage medium storing at least one instruction, at least one program, a code set or an instruction set, wherein the at least one instruction, the at least one program, the code set or the instruction set is loaded and executed by one or more processors to implement the method for determining band information according to claim 1.

39. A non-transitory computer-readable storage medium storing at least one instruction, at least one program, a code set or an instruction set, wherein the at least one instruction, the at least one program, the code set or the instruction set is loaded and executed by one or more processors to implement the method for determining band information according to claim 17.
